(19) United States
(12) Patent Application Publication
(10) Pub. No.: US 2020/0384466 A1
(43) Pub. Date: Dec. 10, 2020

(54) LOADING AND SEALING SAMPLE ON MICROFABRICATED CHIP

(71) Applicant: General Automation Lab Technologies Inc., San Carlos, CA (US)

(72) Inventors: Marc Glazer, San Carlos, CA (US); Alexander Hallock, San Carlos, CA (US); Jude Dunne, San Carlos, CA (US)

(21) Appl. No.: 16/894,843

(22) Filed: Jun. 7, 2020

Related U.S. Application Data
(60) Provisional application No. 62/858,978, filed on Jun. 7, 2019.

(51) Int. Cl. B01L 3/00

(52) U.S. Cl. CPC B01L 3/502715; B01L 3/50273; B01L 2200/027; B01L 2200/0642; B01L 2300/0887; B01L 2400/049; B01L 2200/0689; B01L 2300/0819

(57) ABSTRACT

A system for loading a sample into microwells of a microfabricated chip. The system can include a vacuum loading module, and can further include a sealing module. The loading module includes enclosed chamber formed a bottom part and a top part. The chamber is provided with at least one vacuum port. The chamber can also be provided with an injection port for injecting a liquid sample into the chamber to thereby load the sample into the microwells of the microchip. The sealing module includes a wheel carrying a sealing film and a mounting platform to position a microfabricated chip, where the rotation of the wheel on the microfabricated chip transfers the sealing film on the top surface of the microfabricated chip. Methods of loading a sample onto the microfabricated chip and sealing the loaded chip are also provided.

### CROSS REFERENCE TO RELATED APPLICATION

This application claims priority to U.S. Provisional Application No. 62/858,978 filed Jun. 7, 2019, the disclosure of which is incorporated herein by reference in its entirety.

### BACKGROUND

Microfabricated chips for culturing cells currently available include a plurality of microwells, usually in a dense array (or arrays) format. The size of the microwells can be in the tens of microns to hundreds of microns, and spacing between the microwells is also very small, e.g., in the range of tens to hundreds of microns.

For microfabricated chips made of hydrophobic materials, such as certain plastics, such small scales of the microwells and their dense packing make it challenging to load aqueous samples, e.g., aqueous suspension/media containing microbial cells, into the microwells, due to capillary forces and other surface tension effects. The small loading volume of the microwells also makes evaporation a significant problem, requiring prompt sealing of the microwell contents. The secureness of the sealing is another challenge as the cells may be cultured for prolonged periods, and defects in the sealing may cause cell proliferation and migration in unintended interstitial space which also lead to cross-examination of neighboring microwell contents.

If the surface of the microfabricated chips is made hydrophilic, loading can be easier. However, secure sealing can be difficult to accomplish because the interstitial area remains covered with the media and microbial sample during loading, which is sealed under the sealing membrane. Cells can grow in such interstitial area between microwells, and such interstitial area can also serve as channels between neighboring microwells for cross-contamination.

The current sealing technology, e.g., sealers for 96 or 384-well plates, is not adequate to handle the sealing of loaded microfabricated chip. Such technology typically focuses on heat sealing, which is not suitable for the microfabricated chip platform because heat-sensitive microbes loaded in the microwells may be damaged. The smaller dimensions of the microwells and their high density and close proximity between neighboring wells also make it much more demanding to seal live, aggressive microbes.

There is a need for devices and methods to perform these sample handling steps that address the above drawbacks of the current technologies, especially for studies of microbes on the microfabricated chip platform.

### SUMMARY

In one aspect, the present disclosure provides a system or systems for loading a sample into microwells of a microfabricated chip having a top surface defining an array of microwells, and sealing the filled contents in the microwells of the chip with a sealing film.

In some embodiments of the chip, each microwell of the array of microwells has a diameter of about 25 μm to about 500 μm. In some embodiments, the surface density of the array of microwells is at least 750 microwells per cm². In some embodiments, the distance between two neighboring microwells in the array of the microwells is less than 500 μm.

The system of the present disclosure can include a loading module (or loader) and/or a sealing module (or sealer). In some embodiments, the loading module comprises a bottom part and a top part. At least one of the bottom part and the top part can include a cavity. When the top part and the bottom part are assembled, an enclosed chamber is formed therebetween. The chamber is dimensioned and configured to accommodate a microfabricated chip. The chamber can be provided with at least one vacuum port which can be opened and closed. When the port is open the chamber is in fluid communication with an external vacuum line. The chamber can be further provided with an injection port for injecting a sample into the chamber.

The loading module can further include a gasket (e.g., an elastic ring) disposed between the bottom part and the top part, the gasket surrounding the chamber. The loader can further comprise a clamp configured to apply a pressure to keep the top part and the bottom part assembled (so as to maintain the sealed status the chamber). The clamp can be installed on a base plate on which the bottom part is positioned or mounted.

The sealer is configured to apply a sealing film onto the top surface of the microfabricated chip. Some embodiments of the sealer include a wheel to carry a sealing film, and a mounting platform configured to mount a microfabricated chip. The wheel can rotate about a rotating axis, and the mounting platform is linearly movable along a direction perpendicular to the rotating axis of the wheel. The wheel and the mounting platform can be configured such that a predetermined amount of pressure is exerted on the top surface of the microfabricated device mounted on the mounting platform while the wheel is rotated on and engaging the top surface of the microfabricated device.

In another aspect, the present disclosure provides a method for loading a liquid sample into microwells of a microfabricated chip having a top surface defining an array of microwells using the loader(s) disclosed herein. The method can include: positioning the microfabricated chip on the bottom part of the loading module; closing the top part and the bottom part of the loading module to thereby form a chamber enclosing the positioned microfabricated chip; connecting the vacuum port with a vacuum line; activating the vacuum line to create a vacuum in the chamber at a desired/predetermined level; injecting a liquid sample into the chamber via the injection port; closing the injection port; and draining excess liquid from the chamber from the vacuum port, e.g., by the action of an external vacuum pump or injector. The method can further include sealing the microwells of the microfabricated chip, e.g., by securing a sealing film on the rim of a wheel, and rotating the wheel against the top surface of the microfabricated chip while maintaining a predetermined pressure between the wheel and the microfabricated chip, thereby transferring the sealing film onto the top surface of the microfabricated chip, sealing the contents of the microwells.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a perspective view illustrating a microfabricated device or chip in accordance with some embodiments.

FIGS. 2A-2C are top, side, and end views, respectively, illustrating dimensions of microfabricated device or chip in accordance with some embodiments.

FIG. 3 depicts an example loading module (or loader) and its components in accordance with some embodiments.

FIG. 4 is an example functional diagram of components of a loading module in accordance with some embodiments.

FIG. 5A depicts another example loading module in accordance with some embodiments.

FIG. 5B depicts the bottom part of the loading module shown in FIG. 5A.

FIG. 6 depicts a sealer for sealing the top surface of a sample-loaded microfabricated chip with a sealing film in accordance with some embodiments.

### DETAILED DESCRIPTION OF EXAMPLE EMBODIMENTS

The present disclosure relates generally to systems and methods for isolation, culturing, sampling, and/or screening of biological entities. A microfabricated device (or a “chip”) is used for receiving a sample comprising at least one biological entity (e.g., at least one cell). The term “biological entity” may include, but is not limited to, an organism, a cell, a cell component, a cell product, and a virus, and the term “species” may be used to describe a unit of classification, including, but not limited to, an operational taxonomic unit (OTU), a genotype, a phylotype, a phenotype, an ecotype, a history, a behavior or interaction, a product, a variant, and an evolutionarily significant unit.

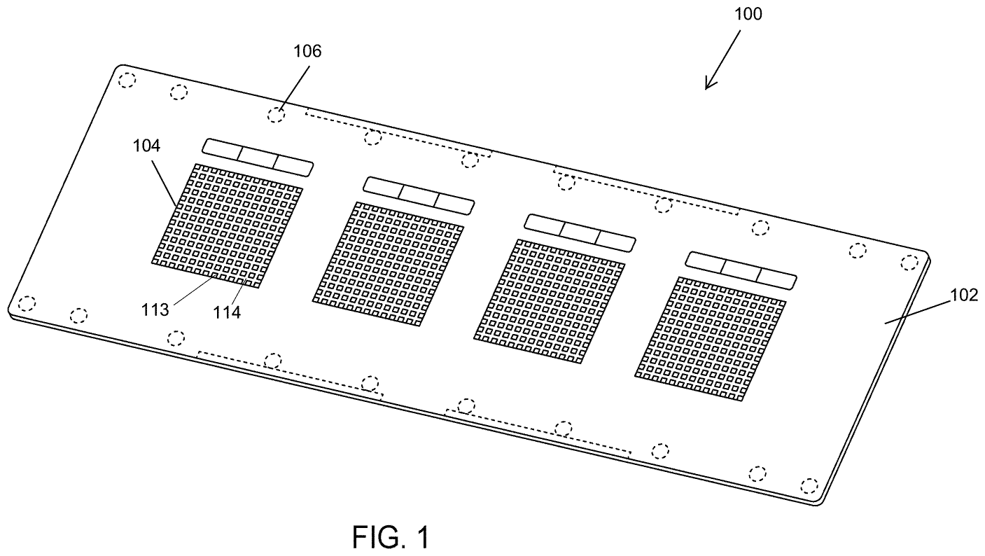

As used herein, a microfabricated device or chip may define a high density array of microwells (or experimental units). For example, a microfabricated chip comprising a “high density” of microwells may include about 150 microwells per cm² to about 160,000 microwells or more per cm² (for example, at least 150 microwells per cm², at least 250 microwells per cm², at least 400 microwells per cm², at least 500 microwells per cm², at least 750 microwells per cm², at least 1,000 microwells per cm², at least 2,500 microwells per cm², at least 5,000 microwells per cm², at least 7,500 microwells per cm², at least 10,000 microwells per cm², at least 50,000 microwells per cm², at least 100,000 microwells per cm², or at least 160,000 microwells per cm²). A substrate of a microfabricated chip may include about or more than 10,000,000 microwells or locations. For example, an array of microwells may include at least 96 locations, at least 1,000 locations, at least 5,000 locations, at least 10,000 locations, at least 50,000 locations, at least 100,000 locations, at least 500,000 locations, at least 1,000,000 locations, at least 5,000,000 locations, or at least 10,000,000 locations. The arrays of microwells may form grid patterns, and be grouped into separate areas or sections. The dimensions of a microwell may range from nanoscopic (e.g., a diameter from about 1 to about 100 nanometers) to microscopic. For example, each microwell may have a diameter of about 1 μm to about 800 μm, a diameter of about 25 μm to about 500 μm, or a diameter of about 30 μm to about 100 μm. A microwell may have a diameter of about or less than 1 μm, about or less than 5 μm, about or less than 10 μm, about or less than 25 μm, about or less than 50 μm, about or less than 100 μm, about or less than 200 μm, about or less than 300 μm, about or less than 400 μm, about or less than 500 μm, about or less than 600 μm, about or less than 700 μm, or about or less than 800 μm. In exemplary embodiments, the diameter of the microwells can be about 100 μm or smaller, or 50 μm or smaller. A microwell may have a depth of about 25 μm to about 100 μm, e.g., about 1 μm, about 5 μm, about 10 μm, about 25 μm, about 50 μm, about 100 μm. It can also have greater depth, e.g., about 200 μm, about 300 μm, about 400 μm, about 500 μm. The microfabricated chip can have two major surfaces: a top surface and a bottom surface, where the microwells have openings at the top surface. Each microwell of the microwells may have an opening or cross section having any shape, e.g., round, hexagonal, square, or other shapes. Each microwell may include sidewalls. For microwells that are not round in their openings or cross sections, the diameter of the microwells described herein refer to the effective diameter of a circular shape having an equivalent area. For example, for a square shaped microwell having side lengths of 10×10 microns, a circle having an equivalent area (100 square microns) has a diameter of 11.3 microns. Each microwell may include a sidewall or sidewalls. The sidewalls may have a cross-sectional profile that is straight, oblique, and/or curved. Each microwell includes a bottom which can be flat, round, or of other shapes. The microfabricated chip (with the microwells thereon) may be manufactured from a polymer, e.g., a cyclic olefin polymer, via precision injection molding or some other process such as embossing. The chip may have a substantially planar major surface. FIG. 1 shows a schematic depiction of a microfabricated chip, whose edges are generally parallel to the directions of the rows and the columns of the microwells on the chip.

The high density microwells on the microfabricated chip can be used to conduct various experiments, such as growth or cultivation or screening of various species of bacteria and other microorganisms (or microbes) such as aerobic, anaerobic, and/or facultative aerobic microorganisms. The microwells may be used to conduct experiments with eukaryotic cells such as mammalian cells. Also, the microwells can be used to conduct various genomic or proteomic experiments, and may contain cell products or components, or other biological substances or entities, such as a cell surface (e.g., a cell membrane or wall), a metabolite, a vitamin, a hormone, a neurotransmitter, an antibody, an amino acid, an enzyme, a protein, a saccharide, ATP, a lipid, a nucleoside, a nucleotide, a nucleic acid (e.g., DNA or RNA), etc.

A cell may be Archaea, Bacteria, or Eukaryota (e.g., fungi). For example, a cell may be a microorganism, such as an aerobic, anaerobic, or facultative aerobic microorganisms. A virus may be a bacteriophage. Other cell components/products may include, but are not limited to, proteins, amino acids, enzymes, saccharides, adenosine triphosphate (ATP), lipids, nucleic acids (e.g., DNA and RNA), nucleosides, nucleotides, cell membranes/walls, flagella, fimbriae, organelles, metabolites, vitamins, hormones, neurotransmitters, and antibodies.

A nutrient may be defined (e.g., a chemically defined or synthetic medium) or undefined (e.g., a basal or complex medium). A nutrient may include or be a component of a laboratory-formulated and/or a commercially manufactured medium (e.g., a mix of two or more chemicals). A nutrient may include or be a component of a liquid nutrient medium (i.e., a nutrient broth), such as a marine broth, a lysogeny broth (e.g., Luria broth), etc. A nutrient may include or be a component of a liquid medium mixed with agar to form a solid medium and/or a commercially available manufactured agar plate, such as blood agar.

A nutrient may include or be a component of selective media. For example, selective media may be used for the growth of only certain biological entities or only biological entities with certain properties (e.g., antibiotic resistance or synthesis of a certain metabolite). A nutrient may include or be a component of differential media to distinguish one type of biological entity from another type of biological entity or other types of biological entities by using biochemical characteristics in the presence of specific indicator (e.g., neutral red, phenol red, eosin y, or methylene blue).

A nutrient may include or be a component of an extract of or media derived from a natural environment. For example, a nutrient may be derived from an environment natural to a particular type of biological entity, a different environment, or a plurality of environments. The environment may include, but is not limited to, one or more of a biological tissue (e.g., connective, muscle, nervous, epithelial, plant epidermis, vascular, ground, etc.), a biological fluid or other biological product (e.g., amniotic fluid, bile, blood, cerebrospinal fluid, cerumen, exudate, fecal matter, gastric fluid, interstitial fluid, intracellular fluid, lymphatic fluid, milk, mucus, rumen content, saliva, sebum, semen, sweat, urine, vaginal secretion, vomit, etc.), a microbial suspension, air (including, e.g., different gas contents), supercritical carbon dioxide, soil (including, e.g., minerals, organic matter, gases, liquids, organisms, etc.), sediment (e.g., agricultural, marine, etc.), living organic matter (e.g., plants, insects, other small organisms and microorganisms), dead organic matter, forage (e.g., grasses, legumes, silage, crop residue, etc.), a mineral, oil or oil products (e.g., animal, vegetable, petrochemical), water (e.g., naturally-sourced freshwater, drinking water, seawater, etc.), and/or sewage (e.g., sanitary, commercial, industrial, and/or agricultural wastewater and surface runoff).

FIG. 1 is a perspective view illustrating a microfabricated device or chip in accordance with some embodiments. Chip 100 includes a substrate shaped in a microscope slide format with injection-molded features on top surface 102. The features include four separate microwell arrays (or microarrays) 104 as well as ejector marks 106. The microwells 113 (spaced by interstitial space 114) in each microarray are arranged in a grid pattern with well-free margins around the edges of chip 100 and between microarrays 104.

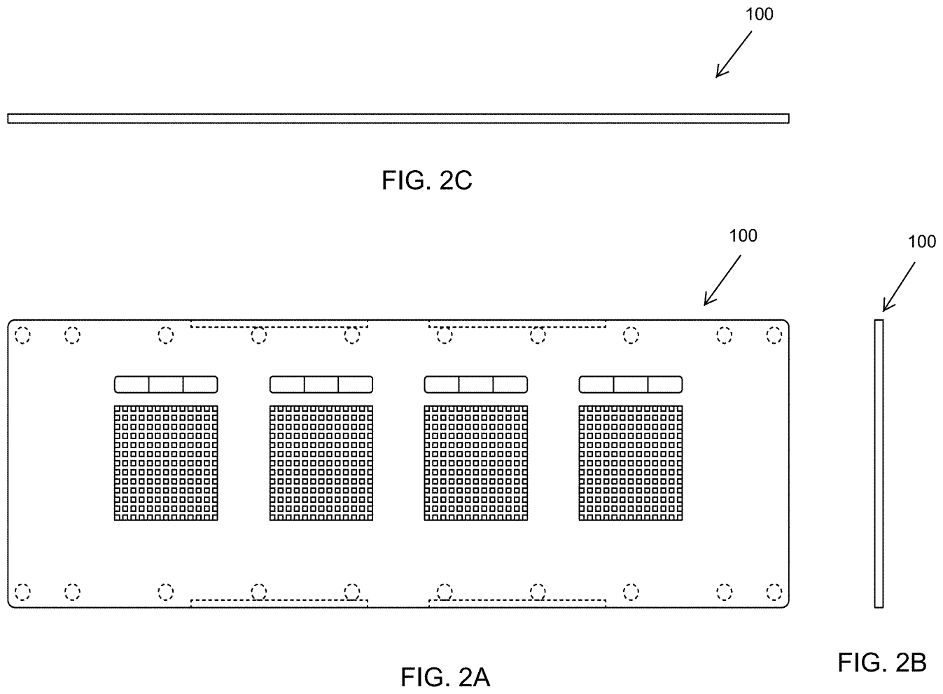

FIGS. 2A-2C are top, side, and end views, respectively, illustrating dimensions of chip 100 in accordance with some embodiments. In FIG. 2A, the top of chip 100 is approximately 25.5 mm by 75.5 mm. In FIG. 2B, the end of chip 100 is approximately 25.5 mm by 0.8 mm. In FIG. 2C, the side of chip 100 is approximately 75.5 mm by 0.8 mm. In general and without limitation, chip 100 may have an overall dimension as follows: a length of between 50 mm and 100 mm, a width of between 20 mm and 50 mm, and a thickness of between 0.5 mm and 3 mm.

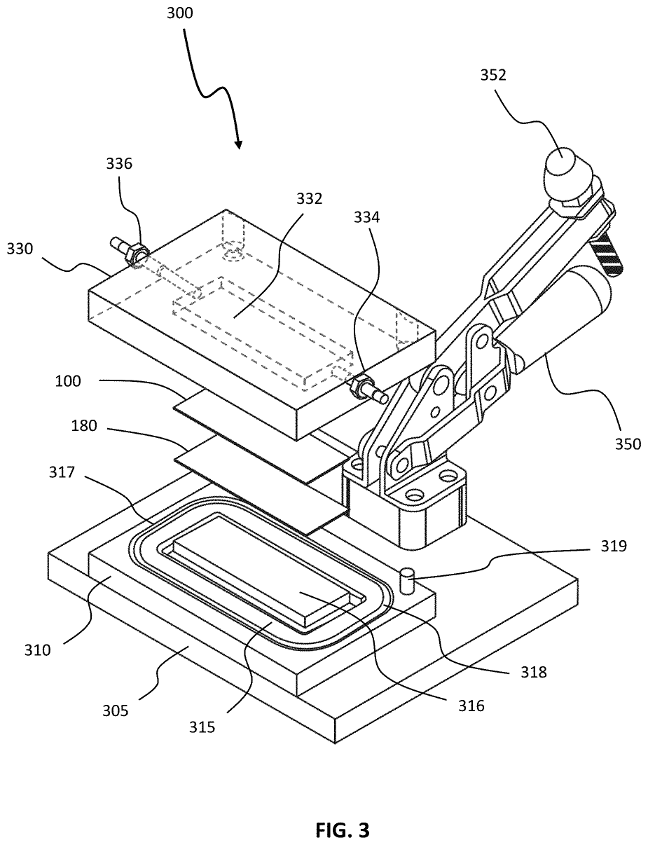

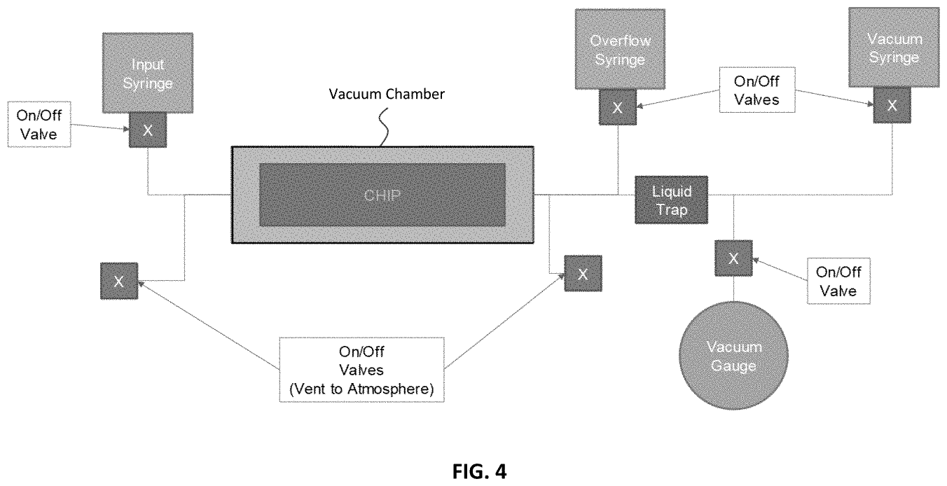

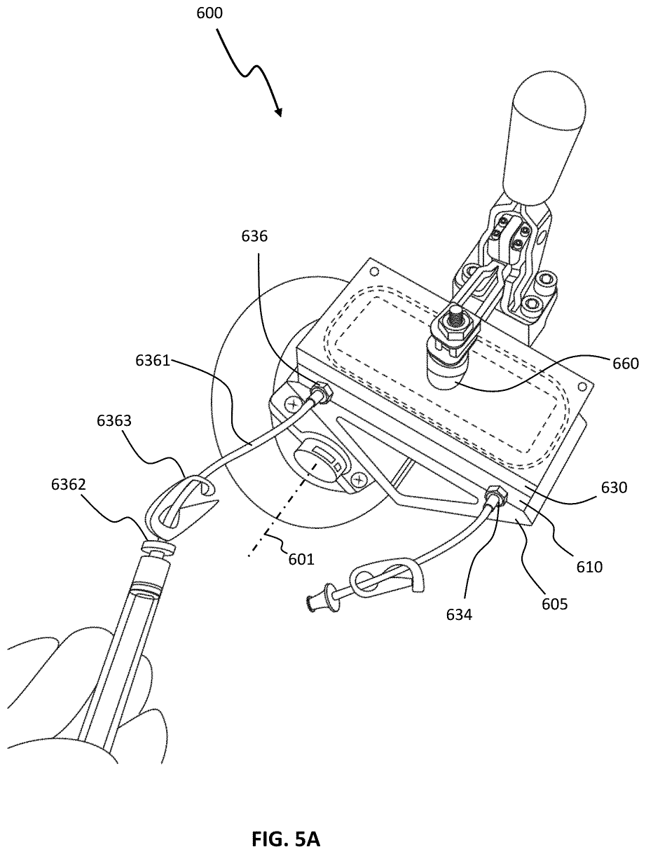

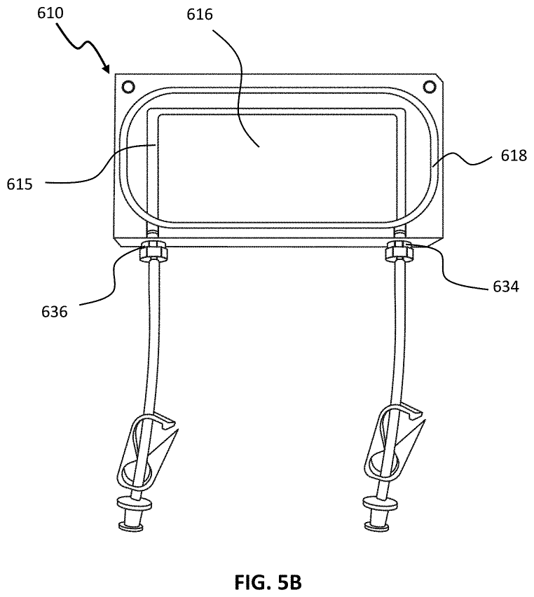

To enable efficient loading of sample into the small wells on a microfabricated chip, the present disclosure provides a loading module (or vacuum loader), which are illustrated in FIG. 3, as well as in FIGS. 4, 5A, and 5B. With reference to FIG. 3, the loading module 300 includes a bottom part 310 installed on a mounting base 305. The bottom part 310 has a central stage 316 for positioning a microfabricated chip 100 (e.g., via a double-sided sticky tape 180), and a groove loop 317 for placing a gasket 318 (e.g., a rubber O-ring). The loading module 300 also includes a top part 330 having a void or cavity 332 open at its bottom to accommodate a microfabricated chip. The cavity 332 is dimensioned to encompass the area of the central stage 316 at the bottom part. A flat surface around the cavity can be pressed against a portion of the upper surface 315 of the bottom part surrounding the central stage 316 to seal the cavity with the chip inside, e.g., by a toggle clamp 350 installed on the mounting base 305. When the top part and the bottom part are assembled, the sealed space formed therebetween is also referred to as chip chamber or vacuum chamber. Although as shown in FIG. 3 the cavity and vacuum/liquid ports are located on the top part (or chip cover), these elements can also be located in the bottom part, as further shown in FIGS. 5A-5B. The chamber can also be formed without cavity at the top part or bottom part, but by the gasket disposed between the top and bottom parts.

After the microfabricated chip 100 is secured on the central stage 316 of the bottom part 310, the top part 330 can be assembled with the bottom part 310 via a guiding pin 319 on the bottom part (and guiding holes on the top part). Fastening bolts (not shown) may be used to secure the top part to the bottom part to form the sealed chip chamber. Alternatively, the top part 330 and the bottom part 310 can be secured together by applying sufficient clamping force using the toggle clamp head 352 against the top part 330, thereby compressing the elastic gasket 318 to retain the desired air-tightness in the chamber.

As shown in FIG. 3, the cavity 332 on the top part 330 (which forms a chamber with the bottom part when the top part and bottom part are assembled) is equipped with at least one port 334 for connecting to a vacuum line. When the connected vacuum system is activated, the chamber can obtain and retain a predetermined level of vacuum. The chamber is also provided with another port 336, which can be used for injecting a liquid sample into the chamber (to therefore load material into the wells of the microfabricated chip), or for draining excess liquid out of the chamber. The vacuum port can also be used for sample injection. As shown in FIG. 3, the two ports 334 and 336 can be positioned on opposing sides of the chamber, which can ensure the sample flow through the entire top surface of the enclosed microfabricated chip during sample loading. The sample can be an aqueous suspension including cells, nutrient, buffer, and/or other reagents/chemicals, etc., depending on the source of the sample and the experiment to be conducted. As further described below, the vacuum port can also be used as overflow/outlet liquid port to drain excess liquid out of the chamber.

FIG. 4 shows example components and functions of an embodiment of the vacuum loader and the interconnection between these components, as well as external devices for loading the sample. These include:
An input syringe with contains a liquid sample to be loaded into the wells of the chip.
The vacuum chamber which holds a microfabricated chip inside.
An overflow syringe (optional) for filling/draining from the outlet side.
A liquid trap for use with a vacuum gauge.
A vacuum gauge for measuring the vacuum level in the system.
A vacuum syringe for evacuating the lines and the chamber.

With reference to FIG. 4, with all valves closed except the vacuum syringe valve, one can draw vacuum until the desired vacuum level is reached, and then close the vacuum syringe valve. When the input syringe valve is opened, a sample loaded in the input syringe can be drawn into the chamber by vacuum, and fill the wells of the chip. After the injection valve is closed, the remaining liquid sample in the chamber (which has not been loaded into the wells) can be drained, e.g., drawn out of the chamber by the overflow syringe or vacuum syringe.

FIG. 5A shows another example of a loading module 600, where the top part 630 and bottom part 610 are assembled to form an enclosed chamber therein, which can accommodate a microfabricated chip. In this case (and will be further shown in FIG. 5B), the two ports 634 and 636 are positioned on the bottom part, and are in fluid communication with the chamber, and can each be connected to vacuum line or sample injection/withdrawal line as needed. For example, port 636 is connected with a tubing 6361 having a terminal connector 6362 (which is connectible with an injector 6362 for injecting or withdrawing sample solution into the chamber), and a line clamper 6363 which can control the open and close status of the tubing 6361.

Sample loading for the loading module 600 shown in FIG. 5A can be accomplished in a similar manner as described above with reference to FIG. 4. The draining of the remaining liquid can be performed when the chamber is held horizontal, or at an inclination angle), such as 30 degrees or greater (e.g., 45 degrees) relative to the horizontal direction. Holding the chamber at an inclination angle can be accomplished by tilting the loading module mounting base 605 along a rotating axis 601 while holding the loading module tightly by the toggle clamp head 660, as shown in FIG. 5A.

FIG. 5B shows a top view of the bottom part 610 of the loading module shown in FIG. 5A (with the top part removed). The elastic gasket 618 forms a loop around the periphery of the bottom part 610. The two ports 634 and 636 are in fluid communication with the space surrounded by the gasket 618 (e.g., by connecting to a loop groove 615 surrounding the central stage 616).

After the completion of vacuum loading of the sample on the microfabricated chip, the clamp is quickly released, the top part of the loading module is removed. The exposed top surface of the chip needs to be quickly sealed to avoid evaporation of liquid in the microwells.

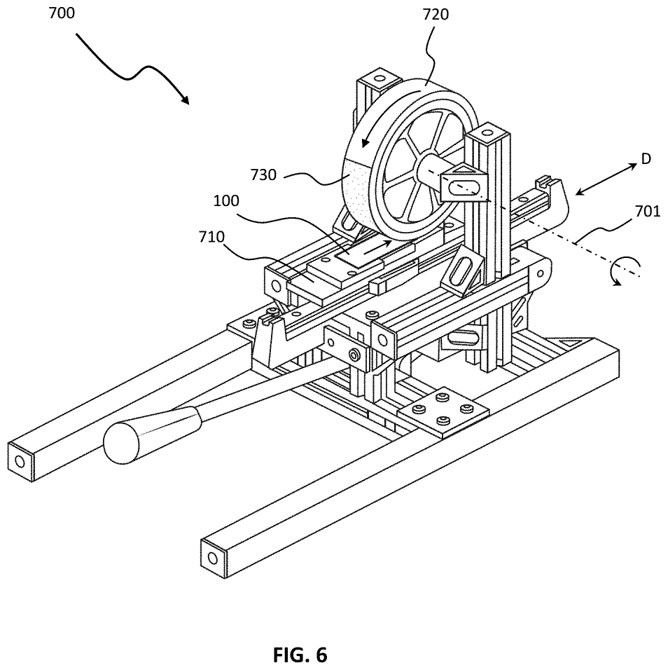

The sealing of a loaded chip can be performed on a sealer (or sealing module) 700, as illustrated in FIG. 6, which include a wheel 720 for carrying a sealing film and a mounting platform 710 to position a microfabricated chip. The sample-loaded chip 100 can be placed on a mounting platform 710, which can move linearly along a direction D perpendicular to the rotating axis 701 of wheel 720. A sealing film 730 has been preloaded on the rim of the wheel 720 (by adhesive, static force, other mechanical engagement mechanisms, etc.). The wheel 720 is rotated and/or the mounting platform 710 moved, so that the sealing film carried on the rim of the wheel 720 engages and is rolled on the top surface of the chip, and transferred to the top surface of the chip while a pressure is maintained between the wheel and the top surface of the chip, thereby retaining the loaded well contents on the chip.

The sealing film can be a natural or synthetic (plastic) membrane which may be impermeable, semi-permeable, selectively permeable, differentially permeable, and/or partially permeable to allow diffusion or nutrient or air into the sealed microwells on the microfabricated chip. The selection of the sealing film regarding its pore size, hydrophobicity, and other characteristics can be based on the cell types loaded in the microwells, cultivation conditions required for the cells, etc. The sealing film may have one side coated with an adhesive for adhering to the top surface of the microfabricated chip to be sealed.

Uniform pressure can be produced by the wheel to produce a reliable result of sealing. It is discovered by the current inventors that for closely arranged wells and with potentially aggressive microbes that can spread between wells with fluid under the seal, the sealing force (pressure) applied in the sealing can affect the sealing result. In one example, at 35 lb force, the sample was able to load into wells (as indicated by fluorescence indicator) but significant spreading of microbes between wells occurs. At 55 lb, microbes spreading between wells becomes much less pronounced, and at 75 lb nearly all wells with growth are isolated.

While the embodiments of the invention have been described herein with reference to particular embodiments thereof, various modifications, changes and substitutions are intended in the foregoing disclosure. It is intended that the invention not be limited to the particular embodiment disclosed, but will include all embodiments and equivalents falling within the scope of the claims.

1. A system for loading a sample into microwells of a microfabricated chip having a top surface defining an array of microwells, comprising:
a bottom part and a top part, at least one of the bottom part and the top part including a cavity such that when the bottom part and the top part are assembled, an enclosed chamber is formed therebetween, the chamber being dimensioned and configured to accommodate a microfabricated chip and provided with at least one vacuum port which can be opened and closed, where when the port is open the chamber is in fluid communication with an external vacuum line.

2. The system of claim 1, further comprising an injection port in fluid communication with the chamber for injecting a sample into the chamber.

3. The system of claim 1, wherein the loading module further includes a gasket disposed between the bottom part and the top part, the gasket surrounding the chamber.

4. The system of claim 1, further comprising a clamp configured to apply pressure to the top part against the bottom part, the clamp installed on a base plate on which the bottom part is positioned.

5. The system of claim 1, further comprising a sealing module configured to apply a sealing film onto the top surface of the microfabricated chip.

6. The system of claim 5, wherein the sealing module comprising a wheel configured to carry a sealing film.

7. The system of claim 5, wherein the wheel is rotatable relative to a mounting platform configured to mount a microfabricated chip, the mounting platform being linearly movable along a direction perpendicular to the rotating axis of the wheel.

8.-9. (canceled)

10. The system of claim 1, wherein each microwell of the array of microwells has a diameter of about 25 μm to about 500 μm.

11. The system of claim 1, wherein the surface density of the array of microwells is at least 750 microwells per cm².

12. The system of claim 1, wherein a distance between two neighboring microwells in the array of the microwells is less than 500 μm.

13. A method for loading a liquid sample into microwells of a microfabricated chip having a top surface defining an array of microwells using the system of claim 1, the method comprising:
positioning the microfabricated chip on the bottom part of the loading module;
closing the top part and the bottom part of the loading module to thereby form a chamber enclosing the microfabricated chip;
connecting the vacuum port with a vacuum line;
activating the vacuum line to create a vacuum in the chamber at a desired level;
injecting a liquid sample into the chamber via the injection port;
closing the injection port; and
draining excess liquid from the chamber from the vacuum port.

14. The method of claim 13, further comprising:
sealing the microwells of the microfabricated chip.

15. The method of claim 14, wherein sealing the microwells comprises:
securing a sealing film on the rim of a wheel;
rotating the wheel against the top surface of the microfabricated chip while maintaining a predetermined pressure between the wheel and the microfabricated chip, thereby transferring the sealing film on the top surface of the microfabricated chip.

16. A method for sealing microwells of a microfabricated chip, comprising:
securing a sealing film on the rim of a wheel;
mounting a microfabricated chip on a mounting platform;
rotating the wheel against the top surface of the microfabricated chip while maintaining a predetermined pressure between the wheel and the microfabricated chip, thereby transferring the sealing film on the top surface of the microfabricated chip.
